(19) United States
(12) Patent Application Publication
(10) Pub. No.: US 2016/0016236 A1
(43) Pub. Date: Jan. 21, 2016

(54) COOLING OR LUBRICANT SUPPLY FOR LATHE TOOLS

(71) Applicant: Rego-Fix AG, Tenniken (CH)

(72) Inventor: Clive Evans, Bristol (GB)

(21) Appl. No.: 14/791,769

(22) Filed: Jul. 6, 2015

(30) Foreign Application Priority Data
Jul. 7, 2014 (CH) 01018/14

(51) Int. Cl. B23B 31/20

(52) U.S. Cl. CPC B23B 31/20; B23B 2231/24; B23B 2250/12; B23B 2231/2081

(57) ABSTRACT

The device for supplying cooling or lubricating fluid to rotationally fixed tools clamped in lathes consists of a clamping nut with an outer cylindrical surface arranged on its outer side, an annular groove arranged therein and connected by bores to the inner side, and an outer sleeve placed onto the outer cylindrical surface and rotatable relative to the clamping nut with a hose connector for supplying cooling or lubricating fluid.

The invention relates to a device for supplying cooling or lubricating fluid to lathe tools that are clamped into lathes according to the preamble of claim 1.

In tool machines with rotating tools having no supply of cooling or lubricating fluid to the cutting edge or only along the outside of the tool, it is known to provide a supply of cooling or lubricating fluid to a channel running on the interior of the tube through appropriate devices (internal cooling). In EP 2 493 654 B1, for example, such a device is described which comprises an inner sleeve that is firmly connected to the inserted tool and an outer sleeve that is stationary relative to the tool, the two sleeves being sealed from one another and the outer sleeve being provided with a connector for a coolant or lubricant line.

The cooling of the cutting edge and the removal of chips during machining is also an important issue in lathes. During material-removing production on automatic lathes, increased service life of the tools and better surface quality can be achieved through targeted cooling on the cutting edge. A solution such as that which is known in rotating tools has previously not been regarded as necessary in lathes, because it is readily possible to supply cooling or lubricating fluid to the cutting edge of a stationary tool.

It has now been found that, even with automatic lathes, it is possible to increase output through the use of internal cooling with optimized cutting parameters.

It is the object of the invention to provide in a lathe a supply for cooling or lubricating fluid to the rear side, i.e., to the side facing away from the cutting edge of a tool provided with a channel for internal cooling. A solution for the internal cooling that is as compact as possible is necessary due to the ever-tighter space conditions in modern sliding headstock automatic lathes.

This object is achieved according to the invention by a device of the type described at the outset that is characterized by the distinguishing features of claim 1.

A preferred exemplary embodiment of the invention is described below with reference to the enclosed drawings.

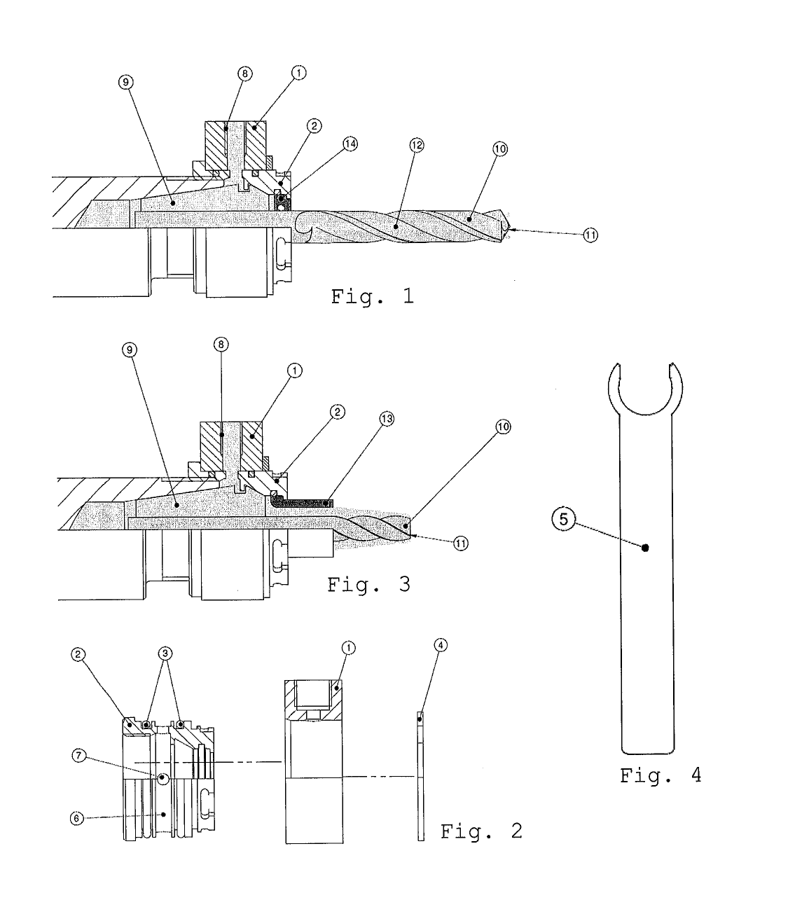

FIG. 1 shows a partially cutaway view of a tool holder of a lathe with a coolant supply device,

FIG. 2 shows an exploded view of the coolant supply shown in FIG. 1,

FIG. 3. shows a partially cutaway view of an alternative embodiment of a supply device according to the invention,

FIG. 4 shows a chuck key that is suitable for the device.

As shown in FIGS. 1 and 2, a tool holder of a lathe has a receiving cone for a conventional HK-type collet 9 with a cylindrical bore for receiving the shaft of a tool 10 with a cutting edge 11. The collet with inserted tool is pressed into the receiving cone in a known manner by means of a clamping nut 2 that is screwed onto an outer thread on the tool holder in order to fix the tool shaft in the collet.

For the screwing on and loosening of the clamping nut, it is provided with an inherently known front-side or radial profile into which a key 5 that fits into the profile grooves and is shown schematically in FIG. 4 engages.

An inherently known gasket 14 is inserted radially within the profile grooves into the tool-side opening of the clamping nut and seals the interior from the outside, so that cooling or lubricating fluid can only reach the cutting edge via a channel present in the tool.

The clamping nut 2 is simultaneously embodied as an inner sleeve of a supply device for cooling or lubricating fluid. For this purpose, an outer cylindrical surface is provided on the outside of the clamping nut with three axially spaced circumferential grooves, the middle groove 6 of which is connected by a number of radial bores 7 to the interior of the clamping nut. The two other grooves receive sealing rings 3.

An annular outer sleeve 1 has an inner cylindrical surface with a diameter which corresponds to the diameter of the outer cylindrical surface of the clamping nut such that a seat of the outer sleeve on the clamping nut or inner sleeve in the manner of a slide bearing is created in the assembled state. In the assembled position, the outer sleeve is secured against axial movement with a lock ring 4, for which the clamping nut has another circumferential groove on the tool side of the outer cylindrical surface. By means of the seal rings 3, a minimal annular gap between inner and outer sleeve is reliably sealed off on both sides of the middle groove. The clamping nut or inner sleeve 2 can thus be rotated in the outer sleeve.

Alternatively, the grooves for the two seal rings can also be arranged in the outer sleeve. It is also possible for the middle groove, in which the distribution of the liquid to the radial bores 7 occurs, to alternatively be arranged in the inner cylindrical surface of the outer sleeve.

The outer sleeve 1 is provided with an inherently known connector 8 for a hose fitting, i.e., with a continuous threaded bore. When the device is loaded with cooling or lubricating fluid, it passes through the bore in the outer sleeve to the middle circumferential groove 6 and further through the bores 7 in the inner sleeve to the collet. The cooling or lubricating fluid passes through the slits of the collet to the rear side of the tool and into an axial channel present in the tool.

By virtue of the rotatability between the outer sleeve and the clamping nut or inner sleeve, the clamping nut can be loosened for a tool change and then retightened without removing the feed hose from the outer sleeve. The tool change can thus be performed very easily directly in the machine.

In the exemplary embodiment shown in FIG. 3, an inherently known cooling disc is inserted into the tool-side opening of the clamping nut that produces a cooling or lubricating fluid layer flowing in a laminar manner along the outside of the tool. This embodiment is otherwise identical to that previously described.

1. A device for supplying cooling or lubricating fluid to rotationally fixed tools clamped in lathes, characterized by
a clamping nut for clamping a collet with inserted tool shaft,
an outer cylindrical surface arranged on the outside of the clamping nut,
one or more bores leading from the outer cylindrical surface to the inside of the clamping nut,
an annular outer sleeve with an inner cylindrical surface that fits on the outer cylindrical surface of the clamping nut such that the outer sleeve can be rotated relative to the clamping nut,
a hose connector leading to the inner surface of the outer sleeve for supplying cooling or lubricating fluid,
an annular groove arranged in one of the cylindrical surfaces for distributing the cooling or lubricating fluid.

2. The supply device as set forth in claim 1, characterized in that the outer cylindrical surface of the clamping nut has a respective additional annular groove on both sides of the annular groove for receiving sealing rings.

3. The supply device as set forth in claim 1, characterized in that the inner cylindrical surface of the outer sleeve has a respective additional annular groove on both sides of the annular groove for receiving sealing rings.

4. The supply device as set forth in claim 1, characterized in that the clamping nut is provided with a profile for the engagement of a chuck key.
